(19) United States
(12) Patent Application Publication
(10) Pub. No.: US 2007/0050634 A1
(43) Pub. Date: Mar. 1, 2007

(54) Service authentication system, server, network equipment, and method for service authentication

(76) Inventors: Yoshinobu Makimoto, Yokohama (JP); Shinichi Sawamura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/515,750

(22) Filed: Sep. 6, 2006

(30) Foreign Application Priority Data
May 13, 2005 (JP) 2005-140719

(51) Int. Cl. G06F 12/14; H04L 9/00; G06F 12/00; H04K 1/00; G06F 13/00; G06F 17/30; G06F 7/04; G06F 7/58; G06K 19/00; G11C 7/00; H04L 9/32

(52) U.S. Cl. 713/182; 726/16; 713/186

(57) ABSTRACT

A service authentication system includes a room entrance/exit manager that manages locations of users, a login manager or remote login manager that manages PC login, an authenticator that performs user authentication, a substitute authenticator that performs various authentications in an integrated manner, and a service management server that stores user authentication information. When the user has requested authentication from the authenticator, the authenticator requests authentication from the substitute authenticator, which then obtains room entrance/exit information from the entrance/exit manager and authentication information from the service management server and authenticates them based on the obtained information.

### INCORPORATION BY REFERENCE

The present application relates to Japanese patent application serial no. 2005-140719, filed on May 13, 2005, the content of which is hereby incorporated by reference into this application.

### BACKGROUND OF THE INVENTION

1. Field of the Invention

The present invention relates to a service authentication system, a server, network equipment, and a method for service authentication, and more particularly to a service authentication technology using information regarding whether or not a user has entered a room in a building.

2. Description of the Related Art

Conventional security systems include a room entrance/exit management system that performs management of entrance/exit of persons to and from a room and an information security system that performs management of access to information stored on a PC or a network. The room entrance/exit management system and the information security system have been operated separately.

The room entrance/exit management system includes an authentication device installed on a door for management of entrance/exit to and from a room. Information used to authenticate a person who enters the room has been stored in the authentication device. The authentication device performs authentication of a person who enters the room by comparing the stored information and information input by the person. A password, an IC card, biometric authentication, or the like is used for authentication for entrance to the room.

The information security system uses an authentication method that requires users to input a password when they are accessing information or a Public Key Infrastructure (PKI) authentication method that uses an X509 certificate. One service provided by the information security system is a remote access service that allows users to remotely access information devices installed in a company from a location outside the company through the Internet. This service is provided using a Virtual Private Network (VPN) connection based on certificate authentication. A system that performs authentication for remote access and provides a service based on the authentication is described in Japanese Patent Application Publication No. 2004-133824.

Although authentication for remote access in Japanese Patent Application Publication No. 2004-133824 can perform authentication of a user who attempts remote access, the authentication system of the Japanese publication cannot specify a place where the user is located. Using the remote access service, the user can obtain information in a company by accessing the information from a remote location even outside the company. If a key or password of the user is stolen, there is a high risk of leakage of information. To prevent the information leakage risk, there is a need to limit service content that can be provided through the remote access service. However, this restricts the service provided to users who are inside the company to the same extent as when the service is provided to users who are outside the company.

### SUMMARY OF THE INVENTION

Therefore, the present invention has been made in view of the above problems, and the present invention provides a service authentication system that does not provide a service when a user authorized to use the service has not entered a room where the service has been requested.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a room entrance/exit and authentication management system;

FIG. 2 is an internal block diagram of each entrance/exit authentication device included in the room entrance/exit and authentication management system;

FIG. 3 illustrates a format of an ID that is assigned to each entrance/exit authentication device or PC;

FIG. 4 illustrates a room entrance/exit state table;

FIG. 5 illustrates an entrance/exit authentication device and room association table;

FIG. 6 illustrates a room entrance/exit log table;

FIG. 7 illustrates an individual and authentication association table;

FIG. 8 illustrates a position query destination table;

FIG. 9 is a sequence diagram illustrating a procedure where a user enters a room;

FIG. 10 is a sequence diagram of a procedure where a user logs into a PC;

FIG. 11 is a sequence diagram of a procedure where a user remotely logs into a PC from a location in the same building;

FIG. 12 is a sequence diagram of a procedure where a user remotely logs into a PC installed in a building from a location in another building;

FIG. 13 is a flowchart of a procedure for a login manager; and

FIG. 14 is a flowchart of a procedure for a remote login manager.

### DESCRIPTION OF THE PREFERRED EMBODIMENTS

Embodiments of a security system, which performs management of entrance and exit of users to and from rooms and management of login of users to PCs, will now be described in detail with reference to the accompanying drawings. Although the following embodiments are described with reference to an example where the security system is installed in each office in a building, the place where the security system can be installed is not limited to the office and the security system may be installed in a condominium or any other facility. Although a service provided by the security system is exemplified by a remote login service in the following description, the applicable services are not limited to the remote login service.

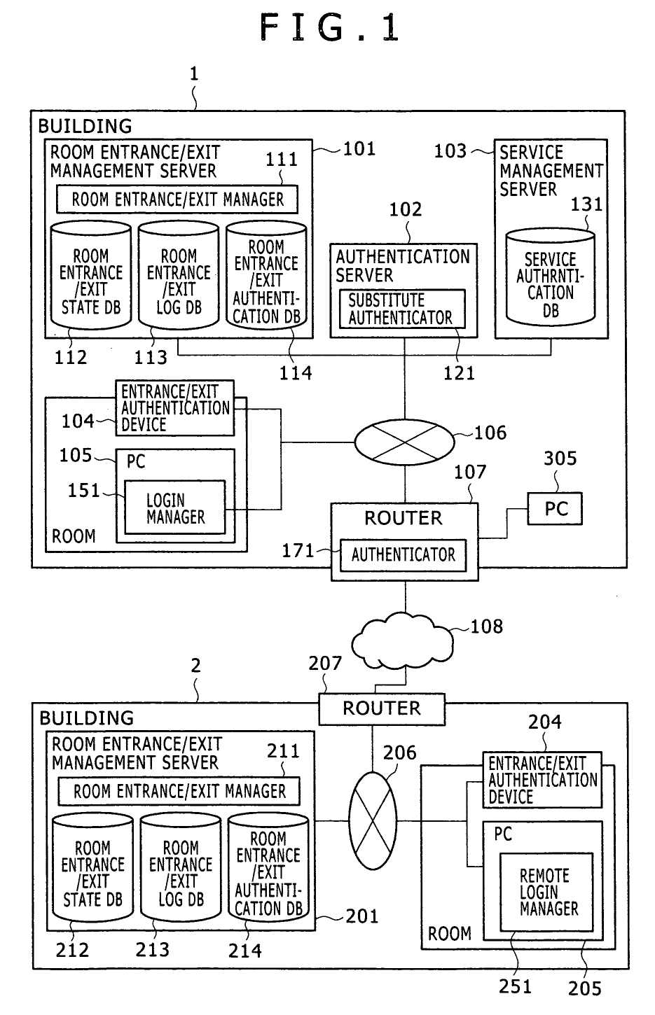

FIG. 1 is a block diagram of a room entrance/exit and authentication management system. As shown in FIG. 1, a room entrance/exit management server 101, an authentication server 102, a service management server 103, an entrance/exit authentication device 104, and a router 107 are connected to a Local Area Network (LAN) 106 in a first building (building 1). Similarly, a room entrance/exit management server 201, an entrance/exit authentication device 204, and a router 207 are connected to a Local Area Network (LAN) 206 in a second building (building 2). The routers 107 and 207 are connected to a network (for example, the Internet) 108.

The room entrance/exit management servers 101 and 201 include room entrance/exit managers 111 and 211, room entrance/exit state databases (DB) 112 and 212, room entrance/exit log DBs 113 and 213, and room entrance/exit authentication DBs 114 and 214, respectively. The authentication server 102 includes a substitute authenticator 121 and collectively performs a variety of service authentication. The service management server 103 includes a service authentication DB 131. The router 107 includes an authenticator 171 and is connected to a PC 305.

A PC 105 including a login manager 151 and a PC 205 including a remote login manager 251 are provided in rooms such as office rooms where the entrance/exit authentication devices 104 and 204 are provided, respectively.

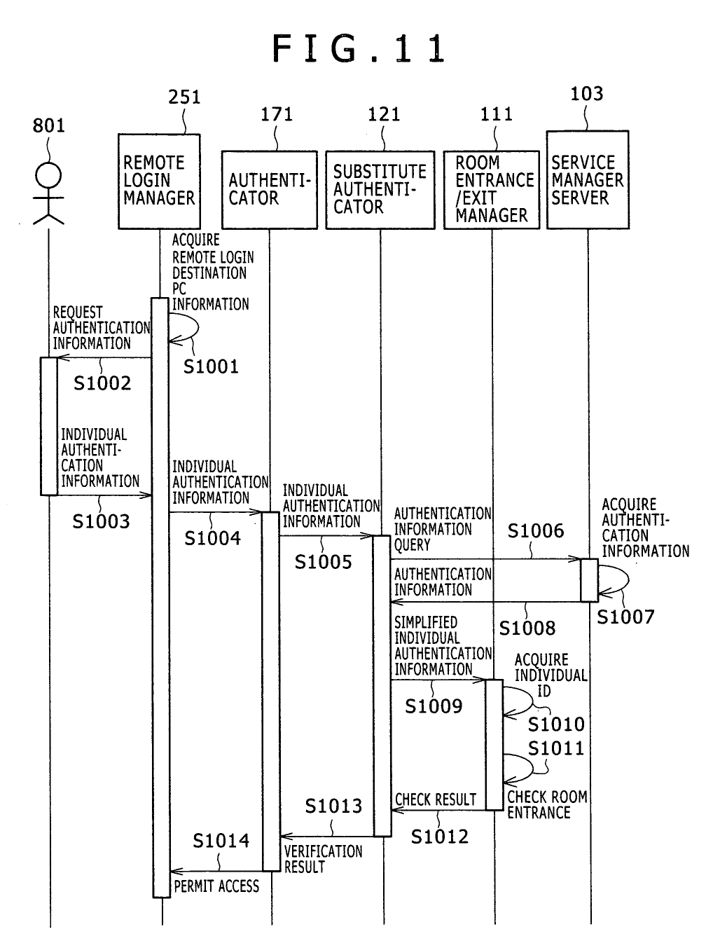

In an example of FIG. 11 which will be described later, the remote login manager 251 is provided in the PC 105 to illustrate a procedure where remote login is performed within the same building.

The room entrance/exit manager 111 performs Transmission Control Protocol/Internet Protocol (TCP/IP) packet communication with the substitute authenticator 121 and the login manager 151 through the LAN 106. In response to requests from the entrance/exit manager authentication device 104 or the substitute authenticator 121, the room entrance/exit manager 111 refers to or updates the room entrance/exit state DB 112, the room entrance/exit log DB 113, and the room entrance/exit authentication DB 114, using Structured Query Language (SQL), and processes data obtained with reference to the DBs and then responds to the entrance/exit manager authentication device 104 or the substitute authenticator 121. The room entrance/exit manager 211 performs communication with the entrance/exit authentication device 204 and performs DB processing in the same manner as the room entrance/exit manager 111.

The substitute authenticator 121 performs TCP/IP packet communication with the room entrance/exit manager 111, the service management server 103, and the authenticator 171 through the LAN 106. In response to requests from the authenticator 171, the substitute authenticator 121 queries the room entrance/exit manager 111 and the service management server 103 and processes responses to the requests and then responds to the authenticator 171.

Upon receiving a request from the substitute authenticator 121, the service management server 103 refers to the service authentication DB 131 according to the request and responds to the substitute authenticator 121 with the reference result.

The entrance/exit authentication devices 104 and 204 are set on doors of the rooms to perform user authentication and to lock and unlock the doors with door keys. An IC card, a biometric authentication, or the like is used for the user authentication. After the user authentication, the entrance/exit authentication device 104 transmits the authentication result to the room entrance/exit manager 111. The entrance/exit authentication device 204 performs user authentication in the same manner as the entrance/exit authentication device 104 and performs communication with the room entrance/exit manager 211.

The login manager 151 is implemented as an application on the PC 105 to allow the PC 105 to perform a login management process. An IC card reader (not shown) is connected to the PC 105. The login manager 151 performs a login or logout process according to whether or not an IC card is present. The login manager 151 transmits a request to check the room entrance of a user to the room entrance/exit manager 111.

The remote login manager 251 is embodied as an application on the PC 205 to allow the PC 205 to perform remote login. An IC card reader is connected to the PC 205. The remote login manager 251 performs remote login (or remote access) or remote logout (or termination of the remote access) according to whether or not an IC card is present. When performing remote login, the remote login manager 251 transmits authentication information to the authenticator 171. The remote login manager 251 also transmits a request to check the room entrance of a user to the room entrance/exit manager 211.

The authenticator 171 transmits authentication information received from the remote login manager 251 to the substitute authenticator 121 and determines whether or not to authenticate the PC 205 according to a response from the substitute authenticator 121. When the authentication is successful, a secure network communication path is established between the PC 205 and the router 107. Each of the PCs may be network equipment such as a server.

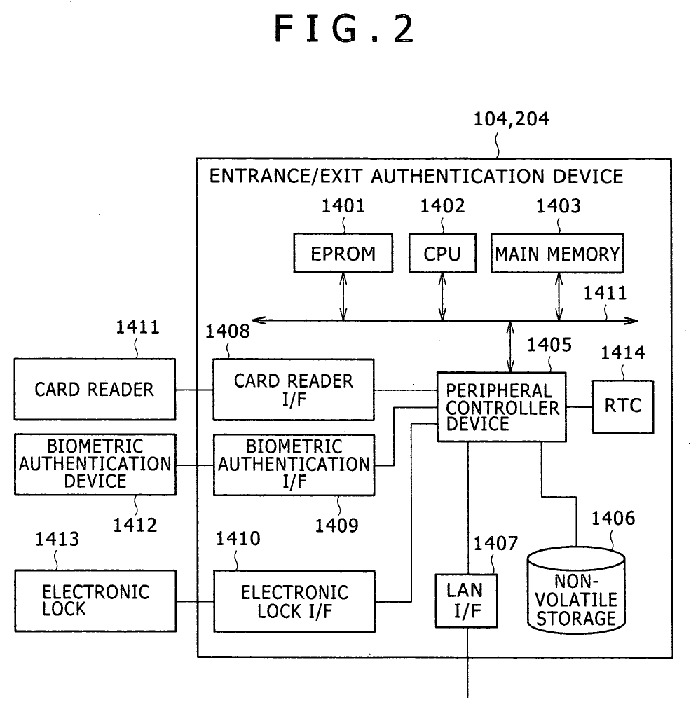

FIG. 2 is an internal block diagram of each entrance/exit authentication device included in the room entrance/exit and authentication management system. As shown in FIG. 2, in each of the entrance/exit authentication devices 104 and 204, an EPROM 1401, a CPU 1402, a main memory 1403, and a peripherals controller 1405 are connected to each other through a bus 1404. A nonvolatile storage 1406, which includes a magnetic disc or a flash memory, a LAN interface 1407, a card reader interface 1408, a biometric authentication interface 1409, an electronic lock interface 1410, and a real time clock (RTC) 1414 are connected to the peripherals controller 1405. A card reader 1411, a biometric authentication device 1412, and an electronic lock 1413 are connected to the card reader interface 1408, the biometric authentication interface 1409, and the electronic lock interface 1410, respectively. The LAN interface 1407 is an interface with the LAN 106 or 206. The RTC 1414 is used for the room entrance/exit management device 104 or 204 to obtain the current time. Each of the interfaces is connected to a corresponding device through a USB or serial connection.

A boot program is stored in the EPROM 1401. When the entrance/exit authentication device 104 or 204 starts up, the CPU 1402 operates according to the boot program. The boot program loads the kernel of an OS from the nonvolatile storage 1405 into the main memory 1403 and starts the OS. When it starts, the OS loads and executes a program for controlling the entrance/exit authentication device 104. Through the peripherals controller 1405, the program for controlling the entrance/exit authentication device 104 performs transmission and reception of signals to and from the card reader interface 1408, the biometric authentication device interface 1409, and the electronic lock interface 1410 and controls the card reader 1411, the biometric authentication device 1412, and the electronic lock 1413.

Each of the card reader 1411 and the biometric authentication device 1412 may include two units provided on both inner and outer sides of the door. Alternatively, the card reader 1411 alone may be provided on both sides of the door and the biometric authentication device 1412 alone may be provided on the outer side of the door. The entrance/exit authentication device 104 or 204, which further includes the card reader 1411, the biometric authentication device 1412, and the electronic lock 1413, may also be referred to as an entrance/exit authentication device. Examples of the biometric authentication device include, but are not limited to, a fingerprint authentication device, a vein authentication device, and an iris authentication device.

The PCs 105 and 205 run in the same procedure as the entrance/exit authentication devices 104 and 205. The PC 105 including the login manager 151 activates the login manager 151 after the OS starts and waits until a user logs in. The PC 205 including the remote login manager 251 waits until a user logs in after the OS starts and activates the remote login manager 251 after the user logs in.

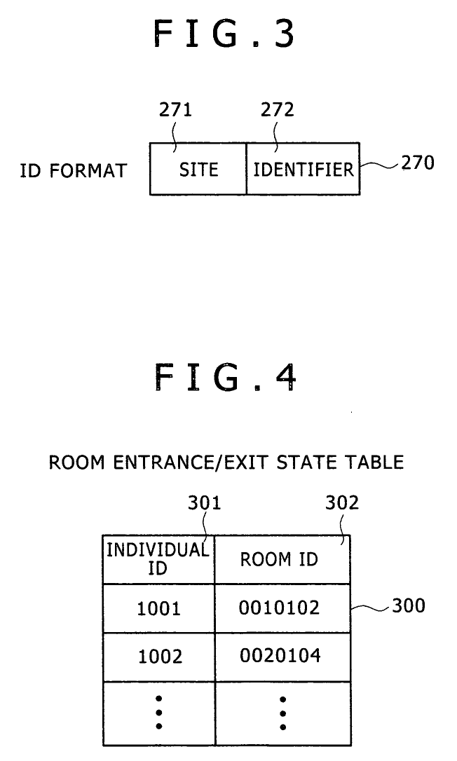

FIG. 3 illustrates a format of an ID that is assigned to each entrance/exit authentication device or PC to uniquely identify the entrance/exit authentication device or PC. As shown in FIG. 3, an ID 270 includes a site field 271 and an identifier field 272. The site field 271 is a 3-digit numerical value uniquely assigned to each building. The identifier field 272 is a 4-digit numerical value that uniquely identifies each device. A combination of the site field 271 and the identifier field 272 is registered as the ID 270. This ensures that, with reference to a site field 271 of an ID assigned to a room, an entrance/exit authentication device, or a PC, it is possible to easily specify a building which includes the room, the entrance/exit authentication device, or the PC.

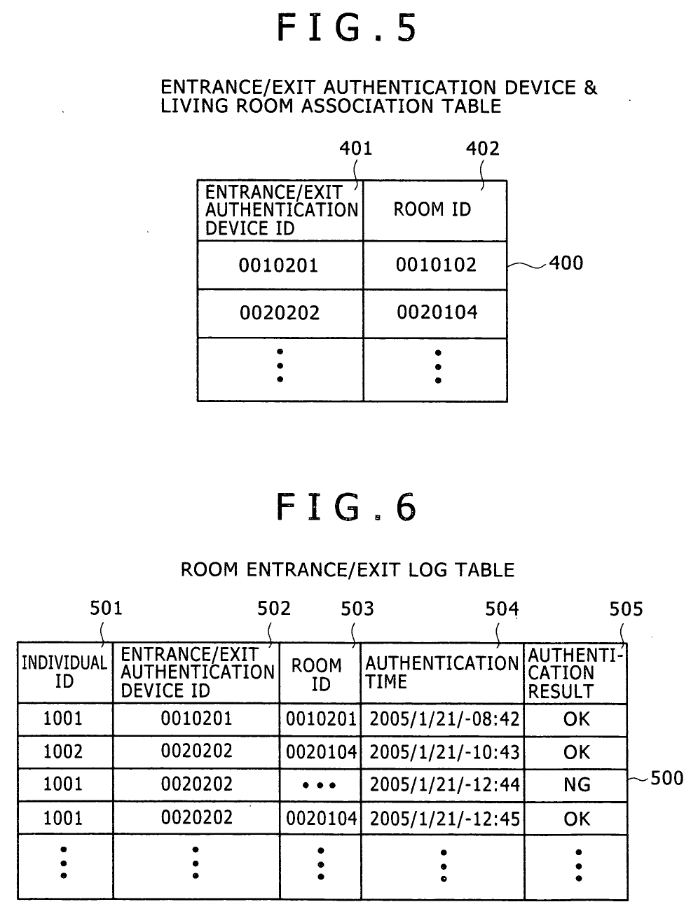

In this embodiment, a site field of “001” is assigned to the first building and a site field of “002” is assigned to the second building. Detailed examples, which comply with this ID format, are entrance/exit authentication device IDs and room IDs shown in FIG. 5, which will be described later.

FIGS. 4 to 8 illustrate tables stored in the DBs. FIG. 4 illustrates a room entrance/exit state table 300. The room entrance/exit state table 300 is a table containing room entrance/exit information stored in the room entrance/exit state DB 112. The room entrance/exit state table 300 includes an individual ID field 301 and a room ID field 302. The individual ID field 301 indicates an individual ID of a user and the room ID field 302 indicates a room ID of a room where the user is located.

FIG. 5 illustrates an entrance/exit authentication device and room association table 400 stored in the room entrance/exit state DB 112. The entrance/exit authentication device and room association table 400 includes an entrance/exit authentication device ID field 401 and a room ID field 402. The entrance/exit authentication device ID field 401 indicates a device ID of an entrance/exit authentication device and the room ID field 402 indicates a room ID of a room which a user is permitted to enter when the user has been authenticated by the entrance/exit authentication device.

FIG. 6 illustrates a room entrance/exit log table 500 stored in the room entrance/exit log DB 113. The room entrance/exit log table 500 includes an individual ID field 501, an entrance/exit authentication device ID field 502, a room ID field 503, an authentication time field 504, and an authentication result field 505. The individual ID field 501 indicates an individual ID of a user, the entrance/exit authentication device ID field 502 indicates a device ID of an entrance/exit authentication device that has performed authentication of the user, and the room ID field 503 indicates a room ID that has been obtained with reference to the entrance/exit authentication device and room association table 400. The authentication time field 504 indicates the time when the authentication was performed and the authentication result field 505 indicates the corresponding authentication result. Since authentication performed at 12:44 on Jan. 21, 2005 failed for some reason as shown in FIG. 6 (i.e. the authentication result is “NG”), a corresponding room ID is left blank.

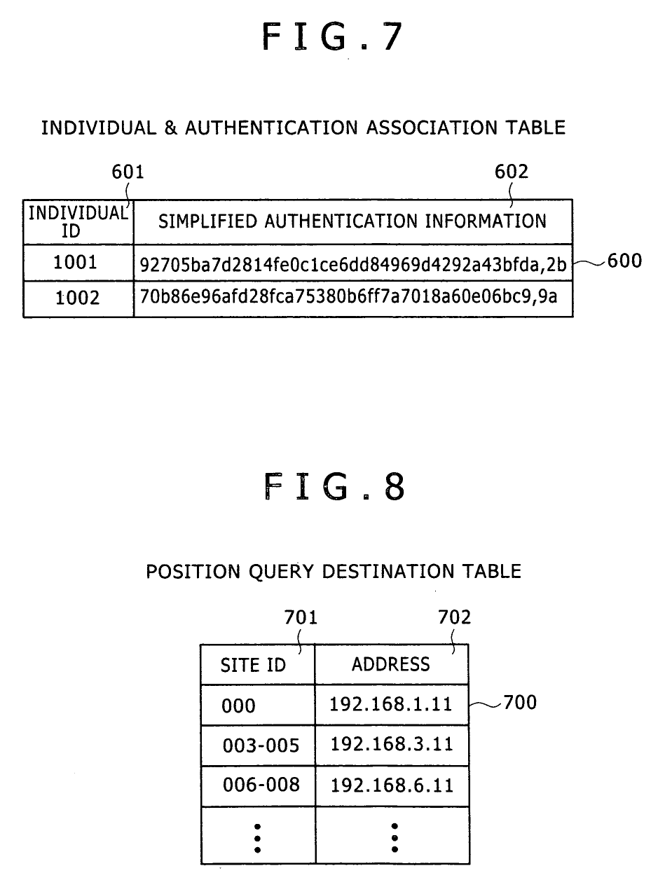

FIG. 7 illustrates an individual and authentication association table 600 stored in the room entrance/exit authentication DB 114. The individual and authentication association table 600 includes an individual ID field 601 and a simplified authentication information field 602. The individual ID field 601 indicates an individual ID of a user and the simplified authentication information field 602 indicates simplified authentication information obtained from authentication information of the user. A copy of a necessary part of the individual and authentication association table 602 is stored in the storage or memory of each of the entrance/exit authentication devices 104 and 204.

Each user is assigned an individual ID and authentication information. The authentication information is used when the user logs into a PC. At this time, the user is specified using the authentication information with reference to the individual and authentication association table 600. The simplified authentication information includes a key identifier and a certificate serial number arranged sequentially and uniquely identifies authentication information.

FIG. 8 illustrates a position query destination table 700 stored in the home entrance/exit managers 111 and 211. The position query destination table 700 includes a site ID field 701 and an address field 702. The site ID field 701 indicates a site ID assigned to each room entrance/exit management server or a range of site IDs (for example, a range of 003-005). The address field 702 indicates an address for which a query is issued when acquiring information regarding the site ID.

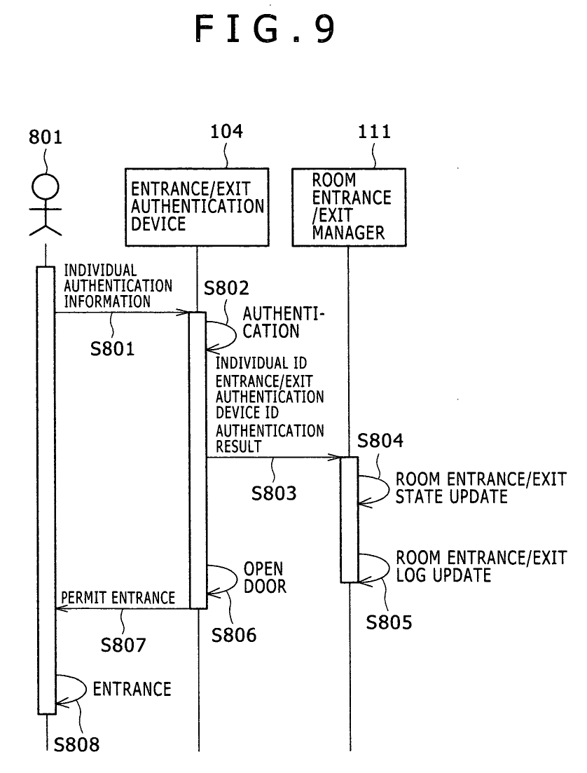

FIG. 9 is a sequence diagram illustrating a procedure where a user enters a room. First, a user 801 inputs individual authentication information to an entrance/exit authentication device (S801). The individual authentication information is input using a card reader connected to the entrance/exit authentication device and a biometric authentication device. When the card reader is used, the user 801 inputs the individual authentication information by placing a card issued to the user 801 on the card reader. An individual ID, a card ID, and a certificate can be used as the individual authentication information. When biometric authentication is performed, biometric information of the user 801 is input as the individual authentication information. The entrance/exit authentication device 104 performs authentication of the input individual authentication information (S802). The entrance/exit authentication device 104 includes a storage or memory that stores a table describing the association between individual authentication information and individual IDs (or a copy of the individual and authentication association table). The entrance/exit authentication device 104 obtains an individual ID corresponding to the input individual authentication information from the association table. When the individual ID cannot be obtained, the entrance is denied. The entrance/exit authentication device 104 also includes a table describing the association between individual IDs and whether or not corresponding users are permitted to enter the room. With reference to this table, it is determined whether to permit or deny the entrance of the user 801 to the room.

The entrance/exit authentication device 104 transmits the individual ID and its device ID, both of which can be referred to as “room entrance authentication information”, and the authentication result to the room entrance/exit manager 111 (S803). Upon receiving the individual ID, the device ID, and the authentication result, the room entrance/exit manager 111 accesses the room entrance/exit state DB to update the entrance state (S804). Specifically, when the result of authentication by the entrance/exit authentication device 104 is “OK”, the room entrance/exit manager 111 obtains a room ID corresponding to the device ID of the entrance/exit authentication device from the entrance/exit authentication device and room association table 400 and adds a set of the individual ID and the room ID to the room entrance/exit state table 300. When the authentication result is “NG”, the room entrance/exit manager 111 deletes a room ID corresponding to the individual ID from the room entrance/exit state table 300. The room entrance/exit manager 111 adds a set of the individual ID, the device ID, the room ID, the current time as the authentication time, and the authentication result to the room entrance/exit log table 500 (S805). If the authentication result is “NG”, the room ID field is left blank.

After step S803, if the authentication result is “OK”, the entrance/exit authentication device 104 opens a door (S806) and permits the entrance of the user 801 (S807). Once the entrance is permitted, the user 801 enters the room (S808). Step S806 may be performed before step S805 and may also be performed before step S804. As described above, when the user 801 enters the room, the entrance of the user 801 is registered in the room entrance/exit state table 300 and the room entrance/exit log table 500.

Although the procedure of FIG. 9 has been described when the user enters the room, the same procedure is performed when the user exits the room and the exit is registered in the room entrance/exit state table 300 and the room entrance/exit log table 500. However, to cope with fire or the like, there is a need to allow emergency exit from the room accompanied by contacting a gatehouse.

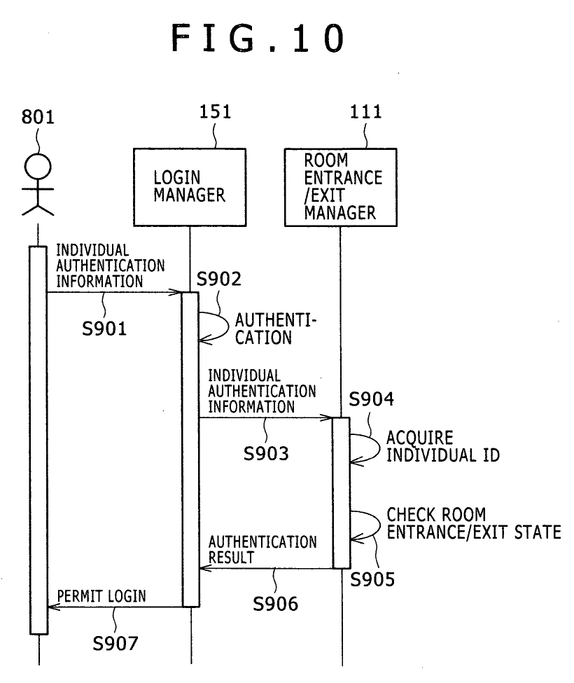

FIG. 10 is a sequence diagram of a procedure where a user logs into a PC which the user owns and uses. The user 801 inputs individual authentication information to the login manager 151 of the PC 105 (S901). The individual authentication information is input using a card reader connected to the login manager 151. The user 801 inputs the individual authentication information by placing a card issued to the user 801 on the card reader. An individual ID, a card ID, and a certificate can be used as the individual authentication information. After inputting the individual authentication information, the user 801 also inputs a user name and a password. The login manager 151 performs authentication of the user name and password (S902). The login manager 151 then transmits the individual authentication information input at step S901 to the room entrance/exit manager 111 (S903).

The room entrance/exit manager 111 has a table describing the association between individual authentication information and individual IDs. After receiving the individual authentication information, the room entrance/exit manager 111 obtains an individual ID corresponding to the received individual authentication information from the association table (S904). When the individual ID cannot be obtained, the authentication result is determined to be “NG”. After obtaining the individual ID, the room entrance/exit manager 111 checks whether the user 801 having the same individual ID has entered or exited the room (S905). Specifically, the room entrance/exit manager 111 queries the room entrance/exit state table 300 in the room entrance/exit state DB 112 and determines that the user 801 has entered the room if the room entrance/exit state table 300 includes a row having the individual ID obtained at step S904. Whether or not the user 801 has entered the room can also be checked with reference to the room entrance/exit log table 500 in the room entrance/exit log DB 113. However, since the room entrance/exit log table 500 has a large table size, the room entrance/exit state table 300 dedicated to describing the entrance/exit states is created and used to increase the speed of processing for checking the entrance/exit state of the user.

If it can be checked at step S905 that the user 801 has entered the room, the room entrance/exit manager 111 determines that the authentication result is “OK”, otherwise it determines that the authentication result is “NG” and transmits the authentication result back to the login manager 151 (S906). If the authentication result received at step S906 is “OK”, the login manager 151 permits the login of the user 801 (S907). If the authentication result received at step S906 is “NG”, the login manager 151 denies the login of the user 801. This allows the user 801 to log into the PC 105 only when the user 801 has entered the room. As a side note, the input of the individual authentication information may also be performed in combination with biometric authentication.

FIG. 11 is a sequence diagram of a procedure where the user 801 remotely logs into the PC 305 from the PC 105 after entering the room. In the description of FIG. 11, it is assumed that the user 801 owns the PC 305 and users share the PC 105. It is also assumed that the PC 105 includes a remote login manager 251 not shown in FIG. 1.

According to manipulation of the user 801 who has logged into the PC 105, the remote login manager 251 in the PC 105 obtains remote login destination PC information (S1001). The remote login destination PC information includes the address and device ID of the remote login destination PC 305. The remote login destination PC information is obtained by reading information written on an IC card of the user 801 through a card reader connected to the PC 105. Here, a site field of the device ID of the remote login destination PC 305 is compared with a site field of the device ID of the PC 105. In this example, both the site fields are identical and it is thus determined that the PCs 105 and 305 are provided in the same building.

The remote login manager 251 requests authentication information from the user 801 (S1002). Upon receiving the authentication request, the user 801 inputs individual authentication information (S1003). Here, it is assumed that an X509 certificate is used as the individual authentication information and the X509 certificate has been written on an IC card issued to the user 801. Specifically, the user 801 inputs the individual authentication information by placing the IC card on the card reader connected to the PC 105. Upon receiving the individual authentication information, the remote login manager 251 transmits the individual authentication information to the authenticator 171 (S1004). The authenticator 171 then transmits the individual authentication information to the substitute authenticator 121 (S1005).

It appears that the authenticator 171 leaves all the authentication to the substitute authenticator 121. The concentration of the substitute authenticator 121 on authentication makes it possible to collectively manage a variety of authentication and simplifies management and authentication processes of authentication information. This embodiment unifies the authentication for PC service management and the authentication for room entrance/exit management.

Upon receiving the individual authentication information, the substitute authenticator 121 queries the service management server 103 for authentication information (S1006). Here, the substitute authenticator 121 requests a certificate issued by a certificate authority (CA) that has applied a signature to the X509 certificate that is the individual authentication information. The service management server 103 obtains the requested information from the service authentication DB 131 (S1007) and transmits it back to the substitute authenticator 121 (S1008).

Upon receiving the authentication information, the substitute authenticator 121 transmits simplified individual authentication information to the room entrance/exit manager 111 (S1009). The simplified individual authentication information, which is included in the X509 certificate, is a set of a key identifier and a certificate serial number of the CA that has issued the certificate. The room entrance/exit manager 111 obtains an individual ID corresponding to the received simplified individual authentication information from the individual and authentication association table 600 (S1010). With reference to the room entrance/exit state table 300 in the room entrance/exit state DB 112, the room entrance/exit manager 111 checks whether or not a row having the individual ID obtained at step S1010 is included in the table 300 (S1011). Based on this checking, the room entrance/exit manager 111 checks whether or not the user 801 has entered the room. Thereafter, if it can be checked at step S1012 that the user 801 has entered the room, the room entrance/exit manager 111 transmits a determination result “OK” back to the substitute authenticator 121, otherwise it transmits a check result “NG” back to the substitute authenticator 121 (S1012).

The substitute authenticator 121 then verifies the individual authentication information received at step S1005 based on the check result received at step S1012 and the authentication information received at step S1008. If the X509 certificate, which is the individual authentication information received at step S1005, is successfully verified based on the CA certificate, which is the authentication information received at step S1008, and the check result obtained at step S1012 is “OK”, the substitute authenticator 121 determines that the verification of the individual authentication information received at step S1005 is successful. The substitute authenticator 121 then transmits the verification result back to the authenticator 171 (S1013).

If the verification result is successful, the authenticator 171 issues an access grant to the remote login manager 251 at step S1014. When the access is permitted, the remote login manager 251 establishes a secure communication path such as a VPN connection between the PC 105 and the router 107 and performs a remote login to the PC 305. In the above manner, remote login from the PC 105 to the PC 305 is permitted only when the user 801 has entered the room and authentication by the service manager is successful.

In the above description, the access is permitted when the user 801 has entered any room. However, whether or not the access is permitted can be determined depending on a room which the user 801 has entered by adding processes described below to the procedure of steps S1006 to S1012. When the substitute authenticator 121 queries the service management server 103 for authentication information at step S1006, the service management server 103 determines, at step S1007, the type of the service based on the contents of the authentication information query and obtains authentication information corresponding to the service and a list of rooms where the service is available. Thereafter, the service management server 103 transmits the authentication information and the serviceable room list of rooms at step S1008. The substitute authenticator 121 then transmits simplified individual authentication information to the room entrance/exit manager 111 at step S1009. When receiving the simplified individual authentication information, the room entrance/exit manager 111 obtains, at step S1010, an individual ID corresponding to the simplified individual authentication information from the individual and authentication association table 601. The room entrance/exit manager 111 then obtains a room ID corresponding to the individual ID obtained at step S1010 from the room entrance/exit state table 301 and transmits the room ID back to the substitute authenticator 121 at step S1012. Upon obtaining the room ID from the room entrance/exit manager 111, the substitute authenticator 121 determines whether or not the room ID obtained at step S1012 is included in the serviceable room list obtained at step S1008. If the room ID is included in the list and the individual authentication information obtained at step S1005 can be verified based on the authentication information obtained at step S1008, the substitute authenticator 121 determines that the authentication result is “OK”. In the above manner, the remote access is permitted only when the user has entered specific rooms.

In the above description, the service is exemplified by a remote access service. However, authenticators may be prepared for services such as a mail service, a service for access to Intranet services, and a web browsing service and each of the authenticators may perform the procedure shown in FIG. 11, so that it is possible to perform authentication including room entrance/exit determination for each service. This makes it possible to determine which services are available or unavailable according to the place where the user is located, thereby allowing provision of highly flexible services. As a side note, the remote login destination PC information may also be input by the user 801 at step S1001.

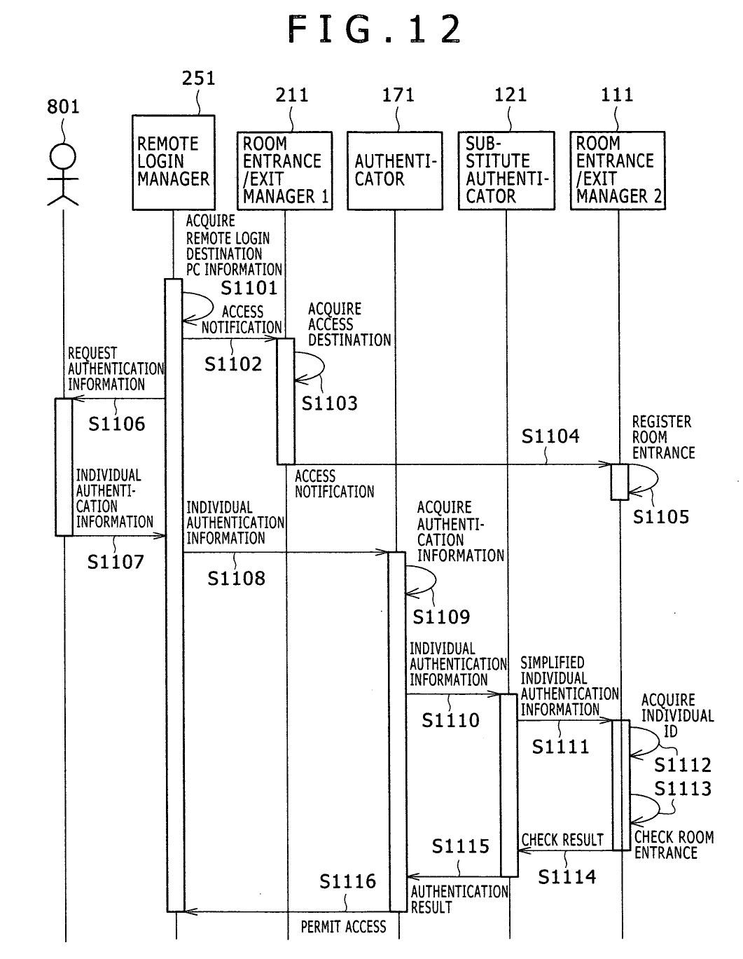

FIG. 12 is a sequence diagram of a procedure where a user remotely logs into their own PC after entering a room in a building other than a building in which the PC is provided. In the description of FIG. 12, it is assumed that the user 801 owns the PC 305 and users share the PC 205. A description similar to that of FIG. 11 is omitted or simplified in the following.

According to manipulation of the user 801 who has logged into the PC 205, the remote login manager 251 in the PC 205 obtains remote login destination PC information (S1101). Here, a site field 271 of the device ID of the remote login destination PC 305 is compared with a site field 201 of the device ID of the PC 205. In this example, both the site fields 271 are different and it is thus determined that the PCs 205 and 305 are not provided in the same building.

The remote login manager 251 then transmits an access notification to the room entrance/exit manager 211 in the same building (S1102). This access notification includes a device ID of the remote login destination PC and an individual ID of the user 801. Upon receiving the access notification, the room entrance/exit manager 211 obtains a site ID of an access destination building from the site field 271 of the device ID included in the access notification. The room entrance/exit manager 211 obtains an address corresponding to the site ID from the position query destination table 700 (S1103). If any address corresponding to the site ID is not found, the site ID is set to “000”. This is because hierarchical position query is achieved by structuring site IDs of room entrance/exit managers of buildings in a tree format such that an address of a new room entrance/exit manager is set to a row including a site ID of “000” in the position query destination table 700 and a set of a site ID and an address of another room entrance/exit manager corresponding to a new descending branch is set to another row. Here, it is assumed that the address of the room entrance/exit manager 111 has been obtained. The room entrance/exit manager 211 also specifies a room which the user 801 has entered using the individual ID included in the access notification. The room entrance/exit manager 211 can specify the room by obtaining a room ID corresponding to the individual ID from the room entrance/exit state table 300 in the room entrance/exit state DB 212. A set of the obtained room ID and the access notification received at step S1102 is defined as a new access notification. The room entrance/exit manager 211 transmits the new access notification to the obtained address (S1104). The access notification transmitted from the remote login manager 251 to the room entrance/exit manager 211 is a service use notification.

Upon receiving an access notification, the room entrance/exit manager 111 obtains a site ID from a site field 271 of a device ID included in the access notification and compares the obtained site ID with a site ID of the room entrance/exit manager 111. If the site ID included in the device ID is identical to the site ID of the room entrance/exit manager 111, the room entrance/exit manager 111 registers a set of the individual ID and the room ID included in the access notification in the room entrance/exit state table 300 in the room entrance/exit state DB 112 (S1105). Thus, a row indicating the entrance/exit state of another building is included in the room entrance/exit state table 300. This row is referred to at step S1113.

A procedure of the following steps S1106 to S1116 is similar to the procedure of steps S1002 to S1014 of FIG. 11. Whether or not the user 801 has entered the room can be checked at step S1113 since the room entrance state of the user 801 was registered at step S1105. In the above manner, remote login from the PC 205 to the PC 305 is permitted only when the user 801 has entered the room and authentication by the service manager is successful. Illustration of steps S1106 to S1116 is simplified in FIG. 12 so that it is different from illustration of the corresponding steps of FIG. 11. Specifically, steps S1006 to S1008 of FIG. 11 are roughly grouped and illustrated as a single step S1109 of obtaining authentication information in FIG. 12.

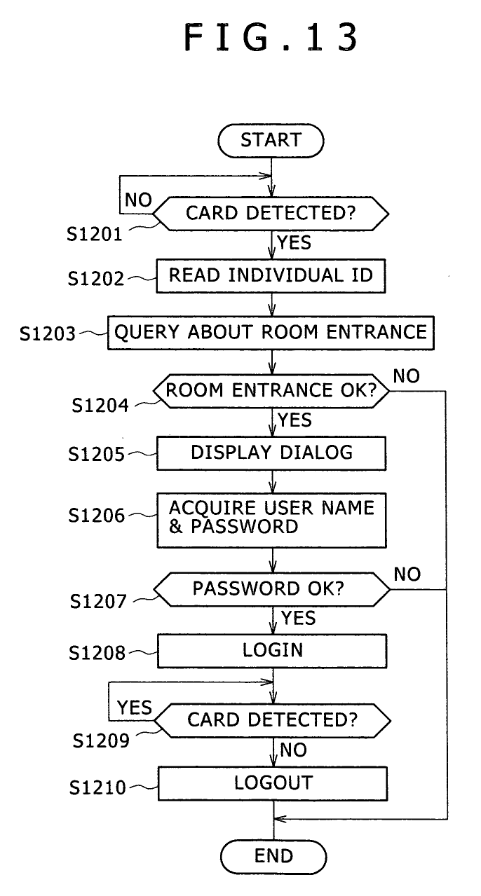

FIG. 13 is a flowchart of a procedure for the login manager 151 where IC card detection by the card reader connected to the PC 105 is considered. First, the login manager 151 performs IC card detection (S1201). If no IC card is detected, the login manager 151 repeats the detection until an IC card is detected. If an IC card is detected, the login manager 151 reads an individual ID from the IC card (S1202). The login manager 151 then queries the room entrance/exit manager 111 whether or not the corresponding user 801 has entered the room (S1203). This process corresponds to step S903 of FIG. 10. The login manager 151 determines the result of the query (S1204) and proceeds to the next step if the user 801 has entered the room.

The login manager 151 displays a dialog to prompt the user 801 to input a user name and a password (S1205). After obtaining the user name and the password (S1206), the login manager 151 performs verification of the password (S1207). If the password verification is successful, the login manager 151 performs login (S1208). The login manager 151 then repeats the card detection (S1209). When the card is no longer detected, the login manager 151 performs logout (S1210).

If it is determined at step S1204 that the user 801 has not entered the room or if the password verification at step S1207 is unsuccessful, the login manager 151 terminates the procedure of FIG. 13. Alternatively, a card access password may be set in each card and the login manager 151 may first display a dialog to prompt the user 801 to input a card access password and then prompt the user 801 to input a user name and a password if the input card access password is correct.

The above procedure makes it possible to perform login when a card is detected and to automatically perform logout when the card is no longer detected. Since the entrance of the user is checked upon login, it is possible to restrict another person from using the PC 105. The login manager 151 may lock the PC 105 rather than perform logout at step S1210. In this case, the login manager 151 unlocks the PC 105 upon detecting the card instead of performing login at step S1208. This makes it possible to temporarily prevent use of the PC while the user is temporarily away. In this case, logout is not performed while the user is away but it is possible to perform logout after a predetermined time has passed from the locking. The login manager 151 may also regularly check the entrance/exit state of the user and then perform logout when the user has exited the building.

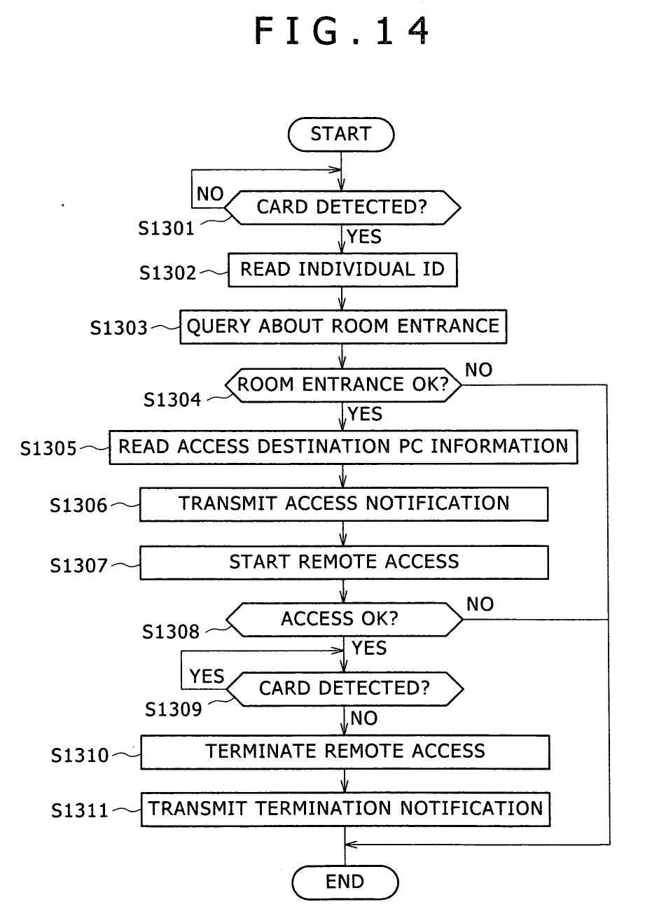

FIG. 14 is a flowchart of a procedure for the remote login manager 251 where IC card detection by the card reader connected to the PC 205 is considered. First, the remote login manager 251 performs IC card detection (S1301). If no IC card is detected, the remote login manager 251 repeats the detection until an IC card is detected. If an IC card is detected, the remote login manager 251 reads an individual ID from the IC card (S1302). The remote login manager 251 then queries the room entrance/exit manager 211 whether or not the corresponding user 801 has entered the room (S1303). The remote login manager 251 determines the result of the query (S1304) and proceeds to the next step if the user 801 has entered the room. The remote login manager 251 then reads access destination PC information (S1305). This corresponds to step S1101 of FIG. 12.

The remote login manager 251 then transmits an access notification (S1306). This corresponds to step S1102 of FIG. 12. The remote login manager 251 then starts remote access (S1307). The remote access is permitted when the procedure of steps S1103 to S1116 of FIG. 12 has been performed properly. The remote login manager 251 determines whether or not the remote access is permitted (S1308). If the remote access is permitted, the remote login manager 251 repeats the card detection (S1309). If the card is no longer detected, the remote login manager 251 terminates the remote access (S1310). The remote login manager 251 then transmits a termination notification (S1311). This termination notification process is similar to the access notification process of steps S1102 to S1105 of FIG. 12. However, the termination notification process is different from the access notification process in that a corresponding row is removed rather than added at a step in the termination notification process corresponding to step S1106 in the access notification process. The procedure of FIG. 14 makes it possible to perform remote access (or login) when a card is detected and to automatically terminate the remote access when the card is no longer detected. Each of the PCs may be network equipment such as a server.

In the above embodiments, room entrance/exit information is incorporated into authentication performed when using a variety of services, thereby making it possible to specify the place where the user is located and to set a fine-grained security policy according to the place.

As is apparent from the above description, the prevent invention provides a service authentication system, a server, network equipment, and a method for service authentication, wherein room entrance/exit information of a user is incorporated into authentication performed when using a service, so that it is possible to specify the place where the user is located and to set a fine-grained security policy according to the place.

Although the preferred embodiments have been disclosed for illustrative purposes, those skilled in the art will appreciate that various modifications, additions and substitutions are possible, without departing from the scope and spirit of the invention as disclosed in the accompanying claims.

What is claimed is:

1. A service authentication system comprising:
a room entrance/exit manager that manages information regarding entrance and exit to and from a room;
an entrance/exit authentication device provided in the room to perform authentication for entrance to the room; and
network equipment provided in the room, said network equipment including a service manager,
wherein, when said entrance/exit authentication device has performed the authentication for the entrance to the room,
said entrance/exit authentication device transmits an authentication result and room entrance authentication information to the room entrance/exit manager, and
said room entrance/exit manager stores the authentication result and the room entrance authentication information and determines whether or not to start a corresponding service based on the stored authentication result and room entrance authentication information upon receiving service start information from the service manager.

2. A service authentication system comprising:
a first network;
a first room entrance/exit management server connected to the first network to manage information regarding entrance and exit to and from a room;
an authentication server that performs service authentication;
a service management server that stores service authentication information;
a second network connected to the first network;
a second room entrance/exit management server connected to the second network to manage information regarding entrance and exit to and from a room;
an entrance/exit authentication device that performs room entrance authentication; and
network equipment including a remote service manager,
wherein, when a user accesses the first network using the network equipment to receive a service, the remote service manager transmits a service use notification to the second room entrance/exit management server,
said second room entrance/exit management server transmits the service use notification and room entrance/exit information of the user to the first room entrance/exit management server,
said first room entrance/exit management server stores the room entrance/exit information,
said remote service manager transmits an authentication request to the authentication server, and
said authentication server obtains the room entrance/exit information from the room entrance/exit management server, obtains authentication information from the service management server, and performs authentication of the user based on the room entrance/exit information and the authentication information.

3. A service authentication system comprising:
a server including a room entrance/exit state database in which room entrance/exit states of users are recorded, a room entrance/exit log database in which a room entrance/exit log is recorded, and a room entrance/exit authentication database in which user IDs and authentication information are recorded;
an authentication server that performs service authentication;
a service management server that stores service authentication information;
a room entrance/exit management server that manages information regarding entrance/exit to and from a room;
an entrance/exit authentication device provided in the room to perform authentication for entrance to the room; and
a network connected to the server, the authentication server, the service management server, the room entrance/exit management server, and the entrance/exit authentication device.

4. The service authentication system according to claim 2, wherein the service is a remote login service.

5. A service authentication system comprising:
a room entrance/exit manager that manages information regarding entrance and exit to and from a room;
an entrance/exit authentication device provided in the room to perform authentication for entrance to the room;
network equipment including a remote login manager;
an authenticator that performs service authentication;
a substitute authenticator that performs various authentication in an integrated manner; and
a service management server that stores service authentication information of users,
wherein, when said entrance/exit authentication device has performed the authentication for the entrance to the room, the entrance/exit authentication device transmits an authentication result and entrance/exit authentication information to the room entrance/exit manager, and
said room entrance/exit manager stores the authentication result and the entrance/exit authentication information as room entrance/exit information in a room entrance/exit database,
when said remote login manager has transmitted a service authentication request to the authenticator, the authenticator transmits a service authentication request to the substitute authenticator upon receiving the service authentication request from the remote login manager, and
upon receiving the service authentication request, said substitute authenticator obtains room entrance/exit information regarding entrance/exit of a user to and from a room in which the network equipment is provided from the room entrance/exit manager, obtains service authentication information from the service management server, and performs authentication of the user based on the room entrance/exit information and the service authentication information.

6. A server connected to an entrance/exit authentication device and a substitute authenticator through a network, the entrance/exit authentication device being provided in a room to perform authentication for entrance to the room, the substitute authenticator being provided to perform service authentication, the server comprising:
a room entrance/exit state database in which room entrance/exit states of users are recorded;
a room entrance/exit log database in which a room entrance/exit log is recorded; and
a room entrance/exit authentication database in which user IDs and authentication information are recorded,
wherein said server updates the room entrance/exit state database and the room entrance/exit log database upon receiving an authentication result of a user from the entrance/exit authentication device, and
upon receiving authentication information from the substitute authenticator, said server obtains a user ID corresponding to the authentication information from the room entrance/exit authentication database, obtains room entrance/exit information corresponding to the user ID from the room entrance/exit state database, and transmits the obtained user ID and room entrance/exit information to the substitute authenticator.

7. Network equipment provided in a room and connected to a card reader and a room entrance/exit manager that manages information regarding entrance/exit to and from the room, the network equipment comprising a service manager,
wherein, when said card reader has detected a card, said service manager specifies a user from authentication information stored in the card and transmits a query as to whether or not the specified user is located in the room to the room entrance/exit manager.

8. A method for service authentication for a service authentication system including a room entrance/exit manager that manages information regarding entrance/exit to and from a room and an entrance/exit authentication device provided in the room to perform authentication for entrance into the room, the method for service authentication comprising the steps of:
inputting individual authentication information to the entrance/exit authentication device;
performing authentication of the individual authentication information by the entrance/exit authentication device;
transmitting an authentication result and entrance/exit authentication information to the room entrance/exit manager; and
updating a room entrance/exit state database in the room entrance/exit manager.

9. A method for service authentication for a service authentication system including a service manager included in network equipment and a room entrance/exit manager that manages information regarding entrance/exit to and from a room, the method for service authentication comprising the steps of:
inputting individual authentication information to the service manager;
authenticating the individual authentication information;
transmitting the authenticated individual authentication information to the room entrance/exit manager;
obtaining an individual ID from the transmitted individual authentication information in the room entrance/exit manager; and
checking a corresponding room entrance/exit state.
